(19) United States
(12) Patent Application Publication
(10) Pub. No.: US 2004/0049392 A1
(43) Pub. Date: Mar. 11, 2004

(54) Content outputting apparatus

(76) Inventor: Tomohiro Yamada, Hyogo (JP)

Correspondence Address: Gerald T. Bodner, Esq., BODNER & O'ROURKE, Suite 108, 425 Broadhollow Road, Melville, NY, 11747, US

(21) Appl. No.: 10/652,402

(22) Filed: Aug. 29, 2003

(30) Foreign Application Priority Data
Aug. 30, 2002 (JP) 2002-253554

(51) Int. Cl. G10L 11/00

(52) U.S. Cl. 704/273

(57) ABSTRACT

A content outputting apparatus includes an MCU, and when an instruction of outputting music data is input, the MCU determines whether or not a license of the music data is obtained. In a case of absence of the license, the music data is not output from a digital terminal. On the other hand, in a case of presence of the license, the music data is output from the digital terminal to an external device. It is noted that even in a case of presence of the license, when the license completely permitting to output the music data is not obtained, noise data is added to an entire or a partial portion of the music data output from the digital terminal. That is, a quality of the music data is lowered.

### BACKGROUND OF THE INVENTION

1. Field of the Invention

The present invention relates to a content outputting apparatus. More specifically, the present invention relates to a content outputting apparatus that outputs from a digital terminal content data reproduced from a recording medium, and outputs from an analog terminal an analog signal based on the content data.

2. Description of the Prior Art

Such the kind of a conventional content outputting apparatus has a digital terminal and an analog terminal for outputting to an external device such as an audio device content data such as music data, and etc. According to a user's instruction, the content outputting apparatus reproduces the music data recorded in an internal memory or an external recording medium attached to the content outputting apparatus and outputs this music data from the digital terminal to the external device, and converts the reproduced content data into an analog music signal and outputs this analog signal from the analog terminal to the external device.

However, the music data is nothing less the music data recorded in an original recording media, or the data decodable to the music data equal in quality to the music data to which a digital compression/modulation is applied, and as a result, these are easily duplicated (copied), thus a problem that gives an unlawful drawback to a copyright owner of the music data.

### SUMMARY OF THE INVENTION

Therefore, it is a primary object of the present invention to provide a content outputting apparatus capable of appropriately limiting an output of content data that needs a copyright protection.

The present invention is a content outputting apparatus that outputs from a digital terminal content data reproduced from a storing medium, and outputs from an analog terminal an analog signal based on the content data, and comprises: a determiner for determining whether or not an output of the content data from the digital terminal is limited; and a lowerer for lowering a quality of the content data output from the digital terminal when a determination result of the determiner is affirmative.

A content outputting apparatus according to the present invention outputs the content data reproduced from the recording medium from the digital terminal, and outputs the analog signal generated based on the content data from the analog terminal. When the content data is reproduced from the recording medium, it is determined whether or not the output of the content data from the digital terminal is limited. In a case that the determination result is herein affirmative, that is, in a case that the output is limited, a quality of the content data is lowered, and then, output from the digital terminal.

In a case that an entire or a portion of a quality of the content data is lowered, and in a case that a portion of the quality of the content data is lowered, for example, the quality of the content data output from the digital terminal is intermittently lowered.

According to the present invention, in a case that the output from the digital terminal is limited, the quality of the content data is lowered, thus possible to appropriately limit the output of the content data that needs a copyright protection.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one example of electric structure of a content outputting apparatus according to the present invention;

FIG. 2 is an illustrative view showing an output of music data according to a presence or absence of a license and kinds of the license;

FIG. 3 is a flowchart showing one portion of an output process of music data of an MCU shown in FIG. 1 embodiment; and

FIG. 4 is a flowchart showing another portion of the output process of the music data of the MCU shown in FIG. 1 embodiment.

### DETAILED DESCRIPTION OF THE PREFERRED EMBODIMENTS

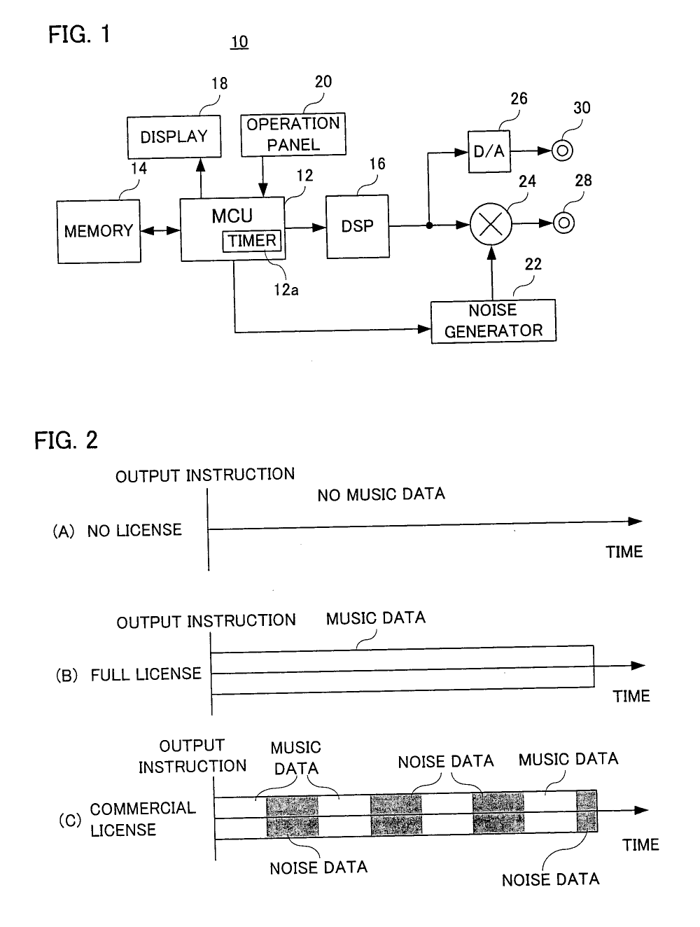

Referring to FIG. 1, a content outputting apparatus (hereinafter briefly referred to as “outputting apparatus”) 10 of this embodiment includes an MCU 12, and a memory 14 is connected to the MCU 12. Furthermore, a DSP 16, a display 18, an operation panel 20, and a noise generator 22 are connected to the MCU 12.

In addition, an adder 24 and a D/A converter 26 are connected to the DSP 16, and the noise generator 22 is connected to the adder 24. Furthermore, a digital terminal 28 is connected to the adder 24, and an analog terminal 30 is connected to the D/A converter 26.

Music data, that is, content data, is stored in memory 14, for example. Such the music data is nothing less than the music data to which a copyright protection is applied or the data having such the music data to which a compression/modulation is applied according to a predetermined format such as an MP3, an AAC, and etc. However, the music data to which the copyright protection is not applied is also recorded.

In a case of reproducing (outputting) the music data, a list of the music data recorded in the memory 14, i.e. a reproduction list, is displayed on the display 18. A user looks at this reproduction list, and operates the operation panel 20, and as a result, the user can select a desired song (music) and input a reproduction instruction (output instruction). When the output instruction is input, the MCU 12, in response thereto, reads-out from the memory 14 the data (music data) corresponding to the music to which the output instruction is applied, and applies the same to the DSP 16. The DSP 16 demodulates the music data according to the predetermined format. It is noted that the music data to which the compression/modulation is not applied is not subjected to a demodulation process in the DSP 16. The music data output from the DSP 16 is output from the digital terminal 28 to an audio device (external device) via the adder 24. In addition, the music data output from the DSP 16 is converted into an analog music signal in by the D/A converter 26, and then, output from the analog terminal to the external device.

It is noted that the music data output from the digital terminal 28 is the music data equal in quality to the original music data, and therefore, unless no treatment is applied, the music data will be easily duplicated (copied). As a result, an unlawful drawback will be given to a copyright owner of the music data.

Thus, in this embodiment, when the music data is read-out from the memory 14, it is determined whether or not the copyright protection is applied to the music data. That is, it is determined whether or not a limit or restriction is present in the output of the music data from the digital terminal 28. Then, in a case that the limit is present in the output of the music data from the digital terminal 28, it is further determined whether or not an outputting authority (license) of the music data is present, and according to a presence or absence of the license and kinds of the license of the music data, the output of the music data is to be limited or restricted.

Herein, the license means information including permission information indicative of an output permission or a limited output permission of the music data (content data), and number of times limiting information indicative of the number of times capable of outputting. Therefore, in a case of the music data to which the copyright protection is applied, and not having such the license, it is absolutely not permitted to output the music data.

It is noted that the music data to which no copyright protection is applied is reproducible (outputtable) at will, irrespective of the presence or absence, and etc. of the license.

More specifically, in a case of absence of the license for the music data, as shown in FIG. 2(A), even if the user inputs the output instruction of the music data, the MCU 12 does not reproduce the music data recorded in the memory 14, and warns the user of not being possible to reproduce (output). The MCU 12 displays a warning message on the display 18, for example. However, a warning sound may be issued, and both the display of the warning message and the issuing of the warning sound may be executed.

On the other hand, in a case of presence of the license for the music data, and in addition, in a case of presence of the license entirely permitting to output the music data (hereinafter referred to as “full license” in this embodiment), as shown in FIG. 2(B), when the user inputs the output instruction of the music data, the MCU 12 outputs the music data recorded in the memory 14 onto the DSP 16. At this time, the noise generator 22 is disabled by the MCU 12.

However, even in a case of presence of the license of the music data, and however, in a case of presence of the license that does not entirely permit to output the music data, that is, the license indicative of the limited output permission (hereinafter referred to “commercial license” in this embodiment), as shown in FIG. 2(C), when the user input the output instruction of the music data, the noise data is added to a portion of the music data, and output from the digital terminal 28. That is, the MCU 12 outputs the music data to the DSP 16, enables the noise generator 22 on predetermined time intervals, and inputs the noise data into the adder 24 on the predetermined time intervals. As a result, the noise data is accumulated (added) to the music data.

Thus, if the noise data is to be added to the music data, it becomes possible to lower a quality of the music data, and as a result, the external device cannot use the music data as such, thus making it possible to protect a copyright concerning the music data. Furthermore, this does not mean that only the noise is output, and a portion of the music is still audible, thus making it possible to encourage a willingness to purchase of the user who has no full license.

However, the noise data may be added to all portions of the music data as long as the noise data is not so loud as to be capable of hearing the reproduced music.

In addition, even in a case of presence of the full license or the commercial license, and however, in a case that the number of times information shows 0, determining that the license is invalid, the music data is not output, and the warning message informing that the license is invalid is displayed on the display 18.

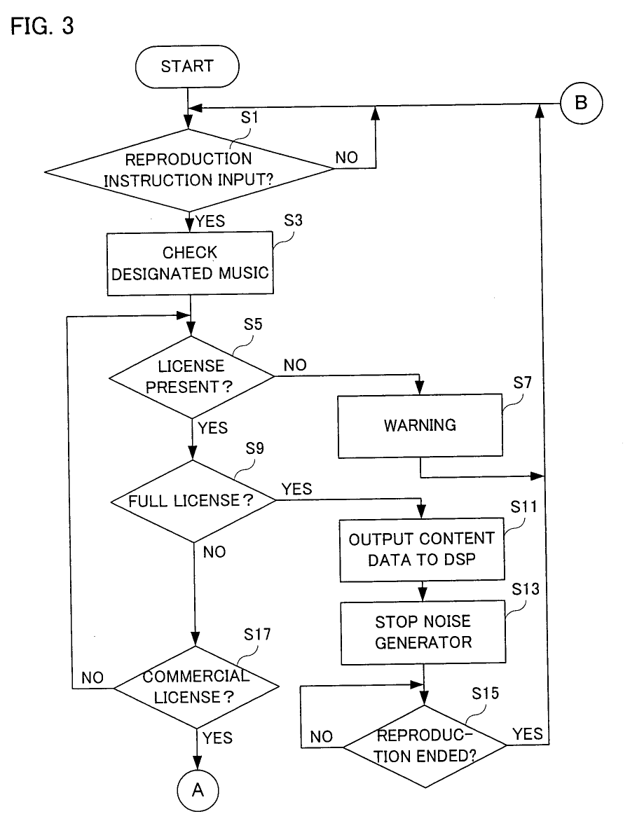

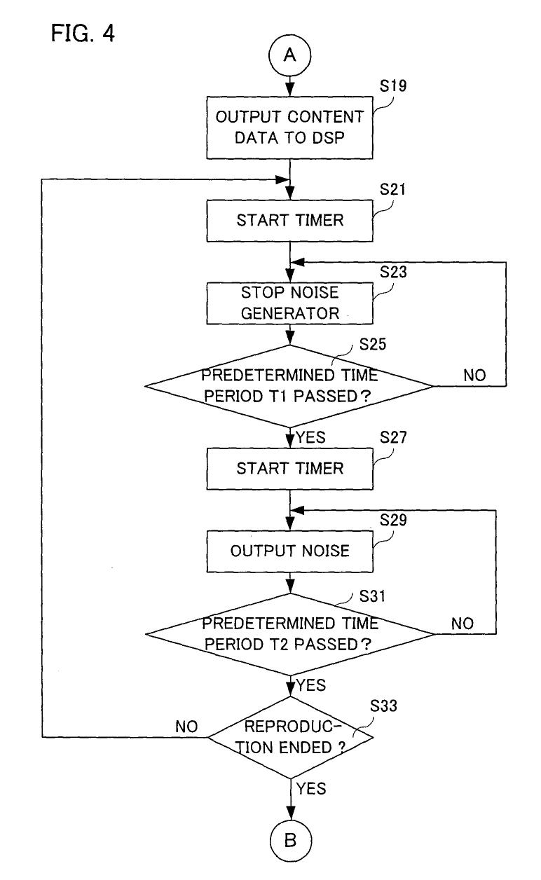

More specifically, the MCU 12 processes flowcharts shown in FIG. 3 and FIG. 4. As shown in FIG. 3, when a main power of the outputting apparatus 10 is turned on, the MCU 12 starts processing so as to determine whether or not the reproduction instruction is input in a step S1. If “NO” in the step S1, that is, if there is no reproduction instruction, the process directly returns to the step S1.

On the other hand, if “YES” in the step S1, that is, if the reproduction instruction is present, a designated music is checked in a step S3. More specifically, it is determined whether or not the copyright protection is applied as to the music data corresponding to the designated music, and in a case that the copyright protection is applied, the presence or absence of the license and kinds of the license are further determined.

In a succeeding step S5, it is determined whether or not the license is present. If “NO” in the step S5, that is, if the license is not present, determining that it is not possible to output the content data (in this embodiment, the music data), the warning message is displayed on the display 18 in a step S7, and then, the process returns to the step S1.

On the other hand, if “YES” in the step S5, that is, if the license is present, it is determined whether or not the license is the full license in a step S9. That is, it is determined whether or not the output of the music data is limited based on the permission information of the license. If “YES” in the step S9, that is, if the full license is present, the music data being instructed to output is output to the DSP 16 in a step S11, the noise generator 22 is suspended (disabled) in a step S13, and then, the process proceeds to a step S15. Therefore, the music data stored in the memory 14 is demodulated by the DSP 16, and the demodulated music data is directly output from the digital terminal 28 via the adder 24. In addition, the music data demodulated by the DSP 16 is converted into an analog music signal by the D/A converter 26, and output from the analog terminal 30. It is noted that if no compression/modulation process was applied to the music data, the DSP 16 directly outputs the music data to a circuit component at a following stage.

In the step S15, it is determined whether or not a reproduction of the music is ended. If “NO” in the step S15, that is, if the reproduction of the music is not ended, the process directly returns to the step S15. On the other hand, if “YES” in the step S15, that is, if the reproduction of the music is ended, the process returns to the step S1.

Furthermore, if “NO” in the step S9, that is, if the full license is not present, it is determined whether or not the license is the commercial license based on the permission information in a step S17. If “NO” in the step S17, that is, if also not having the commercial license, the process returns to the step S5 so as to determine the presence or absence of the license once again, determining that a determination in the step S5 is incorrect.

On the other hand, if “YES” in the step S17, that is, if the commercial license is present, the music data being instructed to output is output to the DSP 16 in a step S19 shown in FIG. 4, a timer 12a included in the MCU 12 is started (reset and started) in a step S21, and the noise generator 22 is stopped in a step S23.

Then, in a step S25, referring to the timer 12a, it is determined whether or not a predetermined time period T1 (10 seconds, for example) has passed. If “NO” in the step S25, that is, if the predetermined time period T1 has not elapsed, the process directly returns to the step S23. On the other hand, if “YES” in the step S25, that is, if the predetermined time period T1 has passed, the timer 12a is started (reset and started) in a step S27, and the noise is output in a step S29. That is, the noise generator 22 is enabled, and the noise data is input into the adder 24.

In a succeeding step S31, referring to the timer 12a, it is determined whether or not a predetermined time period T2 (in this embodiment, 10 seconds) has elapsed. If “NO” in the step S31, that is, if the predetermined time period T2 has not passed, the process directly returns to the step S29. On the other hand, if “YES” in the step S31, that is, if the predetermined time period T2 has passed, it is determined whether or not the reproduction is ended in a step S33.

If “NO” in the step S33, that is, if the reproduction is not ended, the process returns to the step S21. On the other hand, if “YES” in the step S33, that is, if the reproduction is ended, the process returns to the step S1 as shown in FIG. 3.

It is noted that for the sake of simplicity, in the processes shown in FIG. 3 and FIG. 4, in a case of presence of the full license and the commercial license, the music data is output irrespective of the number of times information, and in a case that the number of times information shows 0, however, the warning message of informing that the license is invalid is displayed on the display 18.

According to this embodiment, in a case of absence of the license of the music data, the music data is not output, and even in a case of presence of the license of the music data, the noise data is added to portions of or the entire of the music data corresponding to the kind of the license, thus lowering the quality of the music data. Thus, the output of the music data that needs the copyright protection is appropriately limited so that it is possible to protect the copyright owner.

It is noted that in the above-described embodiment, the specific times T1 and T2 are predetermined to the same time; however, it is not always the case, and these times may freely be set by a system designer, a developer, and et al.

Furthermore, the content data is not always the music data, and various data protected by the copyright such as image data, map data, text data, and etc. are included. Each of such the image data, the map data, text data, and etc. is output to an external device such as a computer, a display, and etc. In a case of limiting such the output, instead of the noise, a mosaic (mask) may be applied to a portion of the image, the map, and the text, and a blurring may be added to all or a portion thereof, for example.

Furthermore, in the above-described embodiment, in a case of absence of the license, the output of the music data is completely not permitted. However, in such the case, the noise data that corresponds to an audibly unbearable sound is output from the noise generator 22, and added to the music data, and then, only the analog music signal may be output.

Still furthermore, in the above-described embodiment, the memory is provided within the outputting apparatus. However, the memory may be an external storing device such as a secure multimedia card, a memory stick, a CD-ROM, a DVD-ROM, or a hard disk drive, and attachable to the outputting apparatus.

Furthermore, in the above-described embodiment, the music data compressed/modulated according to the predetermined format such as the MP3, the AAC, and etc. is demodulated to be output from the digital terminal. However, this music data may be directly output without being demodulated.

Moreover, in the above-described embodiment, the noise data is added to all or a portion of the music data (content data), and as a result, the quality of the content data is lowered. However, a mask may be applied to all or a portion of the content data, or a scramble may be applied. In such the case, instead of the noise generator, a circuit component for applying the mask or the scramble is provided.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content outputting apparatus that outputs from a digital terminal content data reproduced from a storing medium, and outputs from an analog terminal an analog signal based on said content data, comprising:
a determiner for determining whether or not an output of said content data from said digital terminal is limited; and
a lowerer for lowering a quality of said content data output from said digital terminal when a determination result of said determiner is affirmative.

2. A content outputting apparatus according to claim 1, wherein said lowerer lowers all of or a portion of a quality of said content data.

3. A content outputting apparatus according to claim 2, wherein said lowerer intermittently lowers the quality of said content data output from said digital terminal when a portion of the quality of said content data is to be lowered.

4. A content outputting apparatus according to claim 1, wherein said lowerer includes an adder for adding noise data to said content data.

5. A content outputting apparatus according to claim 1, wherein said lowerer includes a scrambler for applying a scramble to said content data.
